(19) United States
(12) Patent Application Publication
(10) Pub. No.: US 2015/0175479 A1
(43) Pub. Date: Jun. 25, 2015

(54) ANTI-SOILING COMPOSITIONS, METHODS OF APPLYING, AND APPLICATION EQUIPMENT

(71) Applicant: 3M INNOVATIVE PROPERTIES COMPANY, SAINT PAUL, MN (US)

(72) Inventors: Katherine A. Brown, Lake Elmo, MN (US); Timothy N. Narum, Lake Elmo, MN (US); Naiyong Jing, Woodbury, MN (US); Timothy J. Hebrink, Scandia, MN (US)

(21) Appl. No.: 14/412,060

(22) PCT Filed: Jul. 3, 2013
(86) PCT No.: PCT/US2013/049300

§ 371 Date: Dec. 30, 2014

Related U.S. Application Data
(60) Provisional application No. 61/668,499, filed on Jul. 6, 2012.

(51) Int. Cl. C03C 17/02; C03C 17/00

(52) U.S. Cl. CPC C03C 17/02; C03C 17/007; C03C 2217/213; C03C 2217/478; C03C 2217/78; C03C 2218/111; C03C 2218/118; C03C 2218/114; C03C 2218/32

(57) ABSTRACT

The present disclosure relates generally to anti-soiling compositions, methods of applying anti-soiling compositions, and equipment for applying anti-soiling compositions. In some embodiments, the present disclosure relates to a method of forming a durable coating on a glass substrate, comprising: (1) applying a coating composition to a glass substrate, the applied coating composition having a thickness of greater than 4 microns; the coating composition consisting essentially of about 0.25% to about 10% by weight of non-oxidizing nanoparticles, an acid, and water; (2) allowing the coating composition to remain on the glass substrate for at least an amount of time sufficient to permit at least some of the nanoparticles to bond to the glass substrate; (3) reducing the thickness of the coating composition to about 0.25 to 4 microns, and (4) evaporating at least some of the water to form the durable coating.

### TECHNICAL FIELD

The present disclosure relates generally to anti-soiling compositions, methods of applying anti-soiling compositions, and equipment for applying anti-soiling compositions.

### BACKGROUND

Renewable energy is energy derived from natural resources that can be replenished, such as sunlight, wind, rain, tides, and geothermal heat. The demand for renewable energy has grown substantially with advances in technology and increases in global population. Although fossil fuels provide for the vast majority of energy consumption today, these fuels are non-renewable. The global dependence on these fossil fuels has not only raised concerns about their depletion but also environmental concerns associated with emissions that result from burning these fuels. As a result of these concerns, countries worldwide have been establishing initiatives to develop both large-scale and small-scale renewable energy resources. One of the promising energy resources today is sunlight. Globally, millions of households currently obtain power from solar energy generation. The rising demand for solar power has been accompanied by a rising demand for devices and materials capable of fulfilling the requirements for these applications.

The performance of glass surfaces of optical components (“optical surfaces”), such as those that transmit, absorb or reflect light when in use, is reduced if/when the optical surface becomes soiled. Soiling generally reduces light transmittance, increases absorbance, and/or increases light-scattering. This is particularly problematic for optical surfaces that are subjected to constant outdoor exposure. Examples of such optical surfaces include, but are not limited to, the glass sun-facing surfaces of photovoltaic (PV) modules, the glass surface of mirrors employed in solar energy generation systems wherein the function of the mirror is to direct incident sunlight to a collecting device or PV module with or without simultaneous concentration of the light, glass lenses (e.g., Fresnel lenses) and glass architectural glazing (e.g., windows). In some applications, glass substrates include a layer of glass and a layer of metal. Mirrors with high specular or total hemispherical reflectance may be used in certain solar energy generation systems, and such mirrors are particularly susceptible to degradation of performance by even small amounts of soiling.

There are many materials that may contribute to soiling, but dust accumulation is a particular problem, especially in dry locations that may experience periods of very low relative humidity, such as deserts. Many attempts have been made to provide to optical surfaces coatings or treatments that will prevent or reduce soiling. However, materials and methods to produce coatings that have no effect on optical performance when initially applied and that retain an acceptable appearance and minimize subsequent soiling on installations in dry, dusty locations have not been disclosed.

### SUMMARY

The inventors of the present application recognized that the performance of optical surfaces is reduced if the surface is soiled. For example, optical surfaces installed outdoors in dry locations accumulate dry dust, particularly during periods of low relative humidity and this soiling can significantly reduce the performance of the optical component. The inventors of the present disclosure discovered coating compositions, application methods, and application devices that reduce the amount of dry dust that accumulates on an optical surface over a period of time.

The inventors of the present disclosure recognized that soiling can result in decreased performance and/or efficiency of a solar energy generating device. Decreased performance and/or efficiency can result in decreased energy generation. The inventors of the present disclosure discovered coating compositions, application methods, and application devices that maintain or increase the amount of energy generated by solar devices.

The inventors of the present disclosure recognized that the composition of air-borne dust, the mechanisms by which it is attracted to, adhered to and adventitiously removed from a glass surface, and the effect of this dust on performance are significantly different than other types of soiling, such as water spotting or the accumulation of oily dirt.

The inventors of the present disclosure recognized that appearance is another important performance requirement of optical surfaces. Appearance is a subjective determination by an observer, and may have little correlation with optical properties, particularly ones which are measured with the aid of an instrument. Appearance is important immediately following application of a coating, and it is preferable that the coating produce no visible optical effects from any viewing angle when first applied. Thus preferred coatings are very thin, preferably less than 50 nm and more preferably less than 40 nm thick, as well as very uniform, containing substantially no voids (uncoated areas) larger than 300 nm, and varying in thickness by no more than 30% of the average coating thickness.

The inventors of the present disclosure recognized that, in addition to initial appearance, the appearance of the coated article must be acceptable throughout the life cycle of the coating on the optical surface. Coatings that provide a useful reduction in the accumulation of dust may accumulate some amount of dust over time, and such dust accumulation preferably occurs uniformly to provide an acceptable appearance. To accomplish this goal, the inventors of the present disclosure recognized that the coating must be uniform when initially applied, so as to provide uniform performance over the lifetime of the coating.

The inventors of the present disclosure recognized that optical components may be installed in environmentally sensitive locations, be operated by persons who are particularly interested in protecting the environment, and/or need to meet various environmental, health, and safety requirements. Environmental, health, and safety requirements are becoming increasing difficult to meet, and there is a need for coating compositions that contain no solvents, surfactants, wetting agents, leveling agents, reactive materials such as coupling agents, or other additives that are typically used to achieve advantageous coating properties, such as uniform spreading and/or adhesion to a surface.

The inventors of the present disclosure recognized that it is preferable for antisoiling coatings to provide outdoor protection against dust accumulation for a period of time. The longer the period of time, the better. Thus it is preferred that the coating be durable. In outdoor environments, organic materials in particular are often susceptible to degradation by ultraviolet light, so the inclusion of organic materials (including, for example, polymers, surfactants, wetting agents, leveling agents, reactive materials such as coupling agents) is preferably avoided.

The inventors of the present disclosure recognized the following additional preferences for coating compositions and methods. It is preferable that the coating be durably adhered to the optical surface. The coating method is preferably suitable for use in a variety of outdoor situations and must not require large, heavy or sophisticated equipment, process controls or highly skilled workers. Equipment or materials that are adjacent to optical surfaces, such as, for example, frames, support structures, racking, structural elements, sealants, caulking, painted surfaces, signing, and the like, must not be damaged or degraded by the coating composition and application method, as might happen if the coating composition was inadvertently applied to an adjacent component and not removed. For example, materials that cause oxidation of organic materials, including photo-activated oxidative materials and thermal or photoactivated oxidative catalysts, are preferably excluded. Particularly in desert locations, water is scarce and the amount of water required for the coating composition and/or application method should be minimal.

The existing art does not describe coating compositions, methods of application, or application tools to simultaneously accomplish many or all of the goals described above. However, the inventors of the present disclosure discovered coating compositions, methods of application, or application tools to simultaneously accomplish many or all of the goals described above. In at least some embodiments, the performance and appearance of the coated article may depend on one or more of coating composition, the coating method, and the tools for applying the coating composition.

In some embodiments, the present disclosure relates to a method of forming a durable coating on a glass substrate, comprising: (1) applying a coating composition to a glass substrate, the applied coating composition having a thickness of greater than 4 microns; the coating composition consisting essentially of about 0.25% to about 10% by weight of non-oxidizing nanoparticles, an acid, and water; (2) allowing the coating composition to sit on the glass substrate for at least an amount of time sufficient to permit at least some of the nanoparticles to bond to the glass substrate; (3) reducing the thickness of the coating composition to about 0.25 to 4 microns, and (4) evaporating at least some of the water to form the durable coating.

In some embodiments, the coating composition consists essentially of about 1% to about 5% by weight of at least one non-oxidizing nanoparticle. In some embodiments, the thickness of the coating composition is reduced to about 0.5 to 3 microns. In some embodiments, at least some of the non-oxidizing nanoparticles have a diameter of between about 2 nm and about 20 nm. In some embodiments, some of the non-oxidizing nanoparticles have a diameter of between about 2 nm and about 20 nm and some of the non-oxidizing nanoparticles have a diameter of between about 20 nm and about 75 nm. In some embodiments, the coating composition contains essentially no oxidizing materials or organic materials.

In some embodiments, the coating composition thickness is reduced using a flexible blade. In some embodiments, the coating composition is applied in no more than two passes over at least 75% of the total glass substrate. In some embodiments, the amount of time sufficient to change the contact angle of the glass substrate is between about 5 seconds and about 60 seconds. In some embodiments, the coating thickness is reduced in no more than two passes over at least 75% of the total glass substrate. In some embodiments, the coating composition is applied by at least one of flooding, rolling, and submerging. In some embodiments, the method further comprises applying a pressure of between about 1 gram/cm and about 60 gram/cm while reducing the thickness of the coating composition. In some embodiments, the durable coating has a thickness of between about 20 nanometers and about 50 nanometers.

In some embodiments, the durable coating has a thickness that varies by no more than 30% over at least 75% of a 10 cm×10 cm area of the glass substrate. In some embodiments, the coating composition self-primes. In some embodiments, the durable coating is invisible. In some embodiments, the durable coating is substantially continuous. In some embodiments, the durable coating contains voids having a size no greater than 300 nm in diameter. In some embodiments, the coating forms a monolayer in at least some areas. In some embodiments, the durable coating has a surface roughness of between about 3 nm and about 75 nm over an area of 5 microns by 5 microns. In some embodiments, the durable coating has an average surface roughness of between about 5 nm and about 40 nm over an area of 5 microns by 5 microns. In some embodiments, at least some of the non-oxidizing nanoparticles adhere to the surface of the glass substrate. In some embodiments, at least some of the non-oxidizing nanoparticles are silica. In some embodiments, the glass substrate is part of a photovoltaic module, window, or solar mirror. In some embodiments, the coating composition includes between about 0.25% to about 10% by weight of non-oxidizing nanoparticles.

Some embodiments of the present disclosure relate to a method of forming a durable coating on a glass substrate, comprising: (1) applying a coating composition to a glass substrate, wherein the coating composition consists essentially of about 0.25% to about 10% by weight of non-oxidizing nanoparticles, an acid, and water; (2) placing a polymer film adjacent to the coating composition; (3) removing the polymer film; and (4) allowing substantially all of the water in the coating composition to evaporate and thereby form the durable coating.

In some embodiments, the coating composition consists essentially of about 1% to about 5% by weight of at least one non-oxidizing nanoparticle. In some embodiments, the thickness of the coating composition is reduced to about 0.5 to 3 microns. In some embodiments, at least some of the non-oxidizing nanoparticles have a diameter of between about 2 nm and about 20 nm. In some embodiments, some of the non-oxidizing nanoparticles have a diameter of between about 2 nm and about 20 nm and some of the non-oxidizing nanoparticles have a diameter of between about 20 nm and about 75 nm. In some embodiments, the coating composition contains essentially no oxidizing materials or organic materials.

In some embodiments, the coating composition thickness is reduced using a flexible blade. In some embodiments, the coating composition is applied in no more than two passes over at least 75% of the total glass substrate. In some embodiments, the amount of time sufficient to change the contact angle of the glass substrate is between about 5 seconds and about 60 seconds. In some embodiments, the coating thickness is reduced in no more than two passes over at least 75% of the total glass substrate. In some embodiments, the coating composition is applied by at least one of flooding, rolling, and submerging. In some embodiments, the method further comprises applying a pressure of between about 1 gram/cm and about 60 gram/cm while reducing the thickness of the coating composition. In some embodiments, the durable coating has a thickness of between about 20 nanometers and about 50 nanometers.

In some embodiments, the durable coating has a thickness that varies by no more than 30% over at least 75% of a 10 cm×10 cm area of the glass substrate. In some embodiments, the durable coating is invisible. In some embodiments, the durable coating is substantially continuous. In some embodiments, the durable coating contains voids having a size no greater than 300 nm in diameter. In some embodiments, the coating forms a monolayer in at least some areas. In some embodiments, the durable coating has an average surface roughness of between about 3 nm and about 75 nm over an area of 5 microns by 5 microns. In some embodiments, the durable coating has an average surface roughness of between about 5 nm and about 40 nm over an area of 5 microns by 5 microns. In some embodiments, at least some of the non-oxidizing nanoparticles adhere to the surface of the glass substrate. In some embodiments, at least some of the non-oxidizing nanoparticles are at least one of silica and alumina. In some embodiments, the durable coating has a contact angle of less than 15. In some embodiments, the glass substrate is part of a photovoltaic module, window, or solar mirror. In some embodiments, the coating composition includes between about 0.25% to about 10% by weight of non-oxidizing nanoparticles. In some embodiments, the method further comprises using a tool to apply pressure to the polymer film. In some embodiments, the tool is at least one of a squeegee and a roller.

Other features and advantages of the present application are described or set forth in the following detailed specification that is to be considered together with the accompanying four drawings.

### BRIEF DESCRIPTION OF DRAWINGS

FIG. 1 is an SEM image at 50,000 magnification of the surface of the coating made as described in Comparative Example 18.

FIG. 2 is an SEM image at 50,000 magnification of the surface of the coating made as described in Example 8.

FIG. 3 is a cross-sectional SEM of the exemplary embodiment shown in FIG. 2.

The figures are not necessarily to scale. It will be understood that the use of a number to refer to a component in a given figure is not intended to limit the component in another figure labeled with the same number.

### DETAILED DESCRIPTION

In the following detailed description, reference may be made to the accompanying set of drawings that form a part hereof and in which are shown by way of illustration several specific embodiments. It is to be understood that other embodiments are contemplated and may be made without departing from the scope or spirit of the present disclosure.

Many solar energy generation devices are installed in locations where solar irradiance is high, due to combination of latitude and climate conditions (e.g., a climate where there is generally very little cloud cover). Further, for utility-scale solar energy installations, a large amount of land is needed. Thus many solar energy systems are advantageously installed in hot, dry climates and, in particular, in deserts. The amount of energy produced by a solar energy system decreases as dust accumulates, resulting in losses of from about 5% to about 40% relative to the originally installed, clean solar energy system. There is also a need to prevent dust accumulation on the windows of buildings. It is time-consuming and expensive to clean windows, and in some locations water for this purpose may be scarce.

Desert locations may have periods of very low relative humidity, as low as 20%—or even as low as 5%—relative humidity, especially during the heat of the day, and the accumulation of dry dust is especially a problem under these conditions. In particular, glass surfaces of optical components installed outdoors in dry locations accumulate dry dust, particularly during periods of low relative humidity. This dust or soil can significantly reduce the performance of the optical component. The composition of air-borne dust, the mechanisms by which it is attracted to, adhered to and adventitiously removed from a glass surface, and the effect of this dust on performance are significantly different than other types of soiling, such as water spotting or the accumulation of oily dirt. Thus preventing soiling by dry dust is a much different problem than preventing other types of soiling. Coatings and surface treatments that may help to prevent water spotting or accumulation of oils or oily dirt may not be effective against dry dust.

Most of the dust that accumulates on glass surfaces in desert locations, particularly for optical surfaces that are several feet off the ground is due to very small, air-borne particles, which may be positively or negatively charged or both. Charged dust particles may be attracted by the electric field produced above the surface of a PV module and/or attracted or repelled by fields produced by triboelectric charging of any glass surface. Triboelectric charging is notoriously unpredictable (see, for example, http://en.wikipedia.org/wiki/Triboelectric), and there are also substantial effects that depend on the position of a given substrate material in the triboelectric series. Further, most air-borne dust particles are very small, typically less than 5 microns in diameter (or, if non-sphereical, its largest dimension is less than 5 microns) and often less than 1 micron in diameter. Without wishing to be bound by theory, it is believed that the adhesion of such small particles to a surface depends on topographical features, especially roughness, on the surface. This may be particularly true if those features are of dimensions that are of similar dimensions as that of the dust particle, for example, from about 1% to about 100% of the size of the dust particle, such that adhesion, such as might be due to van der Waals forces, is reduced due to the reduced contact area between the particle and the rough surface.

Many optical surfaces, in solar energy generating systems and on windows, have been designed to have specific properties, which may be related to performance (transmission, absorption, reflectance, haze, scattering/diffusion, etc.) or aesthetics (color, reflectance, etc). Often, these properties are provided in the glass as part of a manufacturing step, prior to installation or incorporation into the final system or structure. Preferably, coatings applied to an installed system or structure do not change these performance or aesthetic properties. Consequently, it is preferable in at least some embodiments, that the final, dry coating be very thin (e.g., less than about 50 nm). For example, a coating of 125 nm may be transparent and provide anti-reflective behavior to a glass surface, but this reduction in reflectivity may be undesirable in some embodiments if a certain amount of reflectance was designed into the glass for its intended function or appearance. Further, at low viewing angles, a coating of 125 nm will have a longer effective pathlength for incident light and give the appearance of being purple or blue. Coatings of 100 nm, or even 75 nm, can provide visual effects, particularly when viewed at low angles. A coating that is less than about 50 nm thick will produce no such visual effects, that is, it will be invisible. As used herein, “invisible” means that the coating will not cause any significant optical effect that may be detected by the human eye.”

Appearance is a subjective determination by an observer, which is a complex function of the physiological human vision system and human vision perception (a topic of much current research that is sometimes referred to as “vision science”) and the observer's expectations and experiences. It may have little correlation with optical properties, particularly ones which are measured with the aid of an instrument. Appearance is important immediately following application of a coating, and it is preferable that the coating produce no visible optical effects as applied, even when the coated article is viewed at a low angle. Appearance is also important as soil accumulates on an optical surface. For example, two windows (A and B) may be equally and uniformly covered with fine dust particles, reducing visibility (transmission) through them. If someone has written “Wash Me!” on window A with their fingertip, this removed some of the soil in the area of the window that was in contact with the fingertip and thus improved the transmission in the written area and thus the average transmission of the entire window. However, most observers will think Window B is “cleaner” because the uniform dust is not as easily perceived as the contrast and recognition provided by the “Wash Me!” message. Thus uniform soiling is preferred. A uniform antisoiling coating over the entire optical surface is thus also preferred. As will be apparent from the Comparative and Example coatings in dry dust tests, coatings of different thicknesses can retain different amounts of dry dust, and thinner coatings may retain greater amounts of dust. Customers are unlikely to buy or use products that have an unacceptable appearance. Consequently, any coating that is applied to an optical surface to prevent soiling will preferably provide an acceptable appearance immediately after application as well as after soil accumulation, and throughout the product lifetime in addition to providing a measureable improved optical performance. When even a small percentage of an optical surface is different, it may be perceived as unacceptable, particularly if there is good contrast.

To achieve acceptable appearance, optical performance, and protection against soiling, it is desirable to control the thickness, uniformity, durability, and surface topography of the coating. A combination of coating composition and coating method may help to achieve the desired coating properties. In some embodiments, the final, dry coating thickness is less than 50 nm on average. In some embodiments, the final, dry coating thickness is less than 40 nm on average. In some embodiments, the final, dry coating thickness is less than 30 nm on average. A uniform coating may be defined with respect to the dry coating thickness, for example, the coating thickness may vary by no more than 30% of the average coating thickness over at least a fraction of the glass substrate, for example, over at least 75% of a substrate area that is 10 cm×10 cm. A coating that is substantially continuous may be defined as a coating containing no bared, uncoated glass or voids that are visible, for example, a coating containing no voids that greater than 300 nm in diameter or, for voids that are not round, voids that are about the same area as a circle of diameter 300 nm. Those skilled in the art will understand that a very small number of defects may be present in a coating that is acceptably substantially continuous and acceptably uniform, for example, a PV module of dimension 30 cm×120 cm may contain 10 small (up to 1 mm in diameter) defects, such as voids, in the coating, that will not substantially measurably reduce the benefits of the coating and that will be acceptable to customers.

Additionally, it is desirable to produce such coatings on substrates in outdoor environments, for example, on installed PV modules in a solar farm, or on the exterior glazing of an existing building. It is generally not possible in these locations to employ the instruments, equipment, process controls, and capture methods which are typically available in a factory or indoor settings. Optical surfaces may be located at various heights and mounted at various angles (e.g., horizontal, vertical, and in some cases even facing partially or fully downward). Additionally, outdoor application requires the use of materials and methods that protect worker safety and which are also safe for use in the environment, that is, that do not cause pollution or pose environmental hazards if used or released during use outdoors. The workers applying the coatings are likely to be relatively unskilled. Further, outdoor application is likely to result in occasional accidental application to unintended adjacent components, such as framing, supports, cables, wiring, signage, and the like. Consequently, it is preferable that the coating composition not damage these other components, either immediately or after dwelling there for long periods of time (e.g., for years if the coating composition were spilled and allowed to dry on adjacent components). To prevent such damage, the coating composition preferable does not contain materials that cause oxidation of organic or polymeric materials, in either the presence or absence of light. Thus, for example, some embodiments of the coating composition do not contain significant amounts of the elements or oxides or sub-oxides of titanium, cerium, silver, iron, and other transition metals. Suitable non-oxidizing metal oxides include oxides of silicon (silica). In some embodiments, the coating liquid does not contain solvents, surfactants, coupling agents comprising an alkoxysilane group, reactive organic groups, or polymers, as these may be unacceptable for release into the environment, particularly in the fragile environments in which solar energy generating systems are often installed. Surfactants may also attract and/or retain some types of soil. Additionally, any organic materials or functional groups are likely to be susceptible to degradation by ultraviolet light and may results in reduced performance and pose environmental risks as they degrade

Forming thin and uniform coatings on a glass surface outdoors without these ingredients is a particularly challenging requirement, as the glass surface is likely to have been exposed to a wide variety of contaminants which might be only partially removed, or not removed at all prior to the application of the coating liquid. The only acceptable means of removal of contaminants from optical surfaces at many solar energy generation systems is the use of water, optionally at a modestly high pressure, optionally with the use of brushes. The usual means to achieve good wetting (uniform spreading of a coating liquid over a surface to be coated so as to produce a uniform dry coating) is to employ surfactants in the coating liquid, but as described above, the use of surfactants is not acceptable for use in solar energy generation systems and in some locations. Additionally, de-wetting of a surface (such as beading or puddling of the coating liquid) becomes significantly more difficult to overcome as the wet (liquid) coating thickness decreases.

The inventors of the present disclosure recognized that a coating method was needed that could provide good wetting, to be used in combination with a coating liquid that was substantially free of solvents, organic materials, organic functional groups, coupling agents, oxidizing materials and surfactants, and that could be used in a variety of outdoor installations to provide a thin (less than 50 nm average thickness), uniform coating on glass that would reduce the accumulation of dry dust.

One exemplary coating composition includes between about 0.25% to about 10% by weight of non-oxidizing nanoparticles, an acid, and water. One exemplary coating composition includes an aqueous continuous liquid phase and dispersed silica nanoparticles. Another exemplary coating composition includes an aqueous continuous liquid and dispersed alumina nanoparticles. For the purpose of the present application, a nanoparticle is a particle less than 20 nm in volume particle average diameter. In some embodiments, the aqueous continuous liquid phase comprises at least 90% by weight of water. The aqueous continuous liquid phase may be essentially free of organic solvents, except for very small amounts as may unavoidably be present as impurities in water supplies used to prepare the coating compositions (typically less than 0.1% and preferably less than 0.01%). Some embodiments of the coating composition include between about 0.25 and about 10 weight percent nanoparticles (weight percent on a solids basis). Some embodiments of the coating composition include 1 to 5 weight percent nanoparticles. The proportions of nanoparticles to water are selected for shelf-life, practicality of shipping, and to optimize the reaction of the nanoparticles with the glass surface, as will be described in more detail below. Preferably, the coating compositions are stable when stored in the liquid form, e.g., they do not gel, opacify, form precipitated or agglomerated particulates, or otherwise deteriorate significantly. It may be useful to prepare compositions that contain as much as 40 weight percent nanoparticles and to dilute these with water prior to application to a glass substrate, so long as the coating composition that is applied to the glass substrate includes nanoparticles in the range of about 0.25 to 10 weight percent.

In some embodiments, the nanoparticles are nominally spherical. The nanoparticles may agglomerate into larger, non-spherical shapes, but substantial agglomeration is not preferred. In order to minimize haze, the nanoparticles have a volume average particle diameter (i.e., a D₅₀) of 20 nm or less. In some embodiments, the spherical nanoparticles have a volume average particle diameter in a range of from 1 to 20 nm, for example in a range of from 2 to 20 nm, and in specific embodiments in a range of from 2 to 10 nm. The nanoparticles may have any particle size distribution consistent with the above 20 nm volume average particle diameter; for example, the particle size distribution may be monomodal, bimodal, or polymodal.

Exemplary commercially available silica nanoparticles for use in the coatings described herein include, for example, nonporous spherical silica nanoparticles in aqueous media (sols). For example, products under the trade designations LUDOX from WR Grace and Company of Columbia, Md., NYACOL from Nyacol Co. of Ashland, Mass., or NALCO from Nalco Chemical Co. of Naperville, Ill. One useful silica sol with a volume average particle size of 5 nm, a pH of 10.5, and a nominal solids content of 15 percent by weight, is available as NALCO 2326 from Nalco Chemical Co. Other useful commercially available silica sols include those available as NALCO 1115 and NALCO 1130 from Nalco Chemical Co., as REMASOL SP30 from Remet Corp. of Utica, N.Y., and as LUDOX SM from WR Grace.

These silica nanoparticle coating compositions, when acidified, can be coated directly onto glass substrates without either organic solvents or surfactants using the methods of this application to produce surprisingly thin coatings. The coating compositions are coatable on various glass substrates with various surface contaminants, and thus variable contact angles, when they are acidified with pH=2 to 3, and even to 5 in some embodiments.

Not wishing to be bound by theory, it is believed that silanol groups (—Si—O—H) on the surface of the silica nanoparticles react (condense) with silanol groups on the glass surface over a period of time while the coating composition is still wet, that is, while it still contains a major portion of the water that was present when initially applied to the glass surface, to produce a glass surface containing bonded silica nanoparticles, that is, nanoparticles that are attached to the glass substrate by a chemical bond (an Si—O—Si bond). Such bonding is different than and more durable than adhesion by, for example, van der Waals forces. This is particularly surprising since silica nanoparticles are known to be surrounded by a layer of water and, further, since the presence of a large amount of water in the coating composition will generally drive this chemical reaction in the opposite direction (hydrolysis rather than condensation). The number of nanoparticles bonded to the glass substrate may be less than one monolayer of nanoparticles, that is, a sub-monolayer. The period of time required to produce the glass surface containing at least some bonded silica nanoparticles depends on the diameter of the nanoparticle (which is related to the surface area of the nanoparticle) and the concentration (percent by weight) of the nanoparticles in the liquid coating composition. Preferably, the nanoparticles are at least 1% by weight of the coating composition. Without being bound by theory, it is believed that the bonded silica nanoparticles on the glass surface act to reduce the receding contact angle of the very thin liquid films that are produced in subsequent steps, reducing de-wetting and enabling the formation of uniform very thin coatings.

In some embodiments, the silica nanoparticles are dispersions of submicron size silica nanoparticles in an aqueous mixture and have an average primary particle diameter of 20 nanometers or less, preferably 15 nanometers or less, and more preferably 10 nanometers or less. The average particle size may be determined using transmission electron microscopy. In some embodiments, the silica nanoparticles are not surface modified. The silica nanoparticles having a diameter of 20 nanometers or less, when acidified, may be used in combination with the coating methods of this application to provide uniform coatings, without the need for additives such as alkoxysilanes, surfactants, wetting agents, leveling agents, or organic solvents.

In some embodiments, larger silica particles are also included in the coating composition in amounts that do not deleteriously decrease the coatability of the composition on a selected substrate and do not produce visible optical effects. These additional silica particles generally have an average primary particle size of greater than 20 to 75 nanometers, preferably 20 to 50 nanometers, and may be used in ratios of 0.2:99.8 to 99.8:0.2, relative to the weight of the silica nanoparticles of less than 20 nanometers. Larger particles are preferably used in ratios of 1:9 to 9:1. Generally the total weight of silica particles (i.e. the total weight of <20 nm and larger silica particles) in the composition is 0.25 to 10 wt. %, preferably 1 to 10 wt. %, most preferably 2 to 7 wt. %.

In some embodiments, the coating composition contains an acid having a pKa (H₂O) of ≦3.5, preferably <2.5, most preferably less than 1. Useful acids include H₂SO₃, H₃PO₄, CF₃CO₂H, HCl, HBr, HI, HBrO₃, HNO₃, HClO₄, H₂SO₄, CH₃SO₃H, CF₃SO₃H, and CH₃SO₂OH. Preferred acids include HCl, HNO₃, H₂SO₄, and H₃PO₄ The coating composition generally contains sufficient acid to provide a pH of less than 5, preferably less than 4. Generally, the coating composition is a solution containing an acid having a pKa (H₂O) of ≦3.5, preferably <2.5, most preferably less than 1. Such nanoparticle coating compositions are described in detail in PCT Patent Publication No. WO 2009/140482, incorporated herein in its entirety.

Coating compositions according to the present disclosure may be made by any suitable mixing technique. One useful technique includes combining an alkaline spherical silica sol of appropriate particle size with water, and then adjusting the pH to the final desired level.

Some coating methods of the present disclosure involve applying the coating composition to the glass surface for a period of time sufficient to allow at least some of the nanoparticles to react with the glass surface. The coating liquid may be applied by methods such as, for example, rolling, flooding, or submersion. Without wishing to be bound by theory, nanoparticles in the coating composition are charged particles that are repelled by like charges. It is thus preferred that application methods do not induce a like charge on the surface to be modified or the particles will be repelled from the surface and will be unable to react with it in a reasonable period of time. Charges may be induced on a surface by the movement of an article past the surface. Preferred application methods do not induce a charge on the glass surface. Application methods that minimize the possibility of triboelectric charging, such as those that require fewer passes of an application tool past the glass surface are preferred. Application methods that require at most two passes over a section of substrate are preferred.

For example, imagine a glass substrate of size 0.4 meter×1.0 meter positioned at a 45 degree angle on a mounting rack with the 0.4 meter edge placed horizontally. In this hypothetical example, a tool used to apply the liquid coating composition is 24 cm long (in width). Passing the tool from the top 0.4 meter edge to the bottom 0.4 meter edge in a single pass with the left edge of the application tool at the left edge of the glass substrate results in application of the coating liquid to just over half of the glass substrate. Passing the tool from the top to the bottom again, with the right edge of the application tool at the right edge of the glass substrate, will result in application of the coating liquid to the remainder of the glass substrate, with an overlapping section of about 8 cm in width in the center of the glass substrate. The substrate has had one pass of the applicator over 80% of its surface, and two passes over 20% of its surface. Repeating these two passes produces a coated substrate that has had two passes of the applicator over 80% of its surface, and four passes over 20% of its surface.

Various combinations of substrate and tool dimensions are possible, as are varying amounts of overlap, from as little as 0% to 90% overlap. It is preferable that the combinations of tool size and overlapping passes provide no more than two passes over a major portion of the glass substrate. For example, a tool will have been passed one or two times over at least 75% of the substrate, and three or more passes will have been made over no more than 25% of the total substrate surface. Methods that result in a large number of passes of a tool over the substrate, for example, repeated circular motions with a cloth, are to be avoided. Application methods that can be used to apply the liquid coating composition to the glass substrate with as few as one pass or at most two passes include, for example, rolling, wiping, brushing, flooding, and submersion. In some embodiments, application by hand tools may be preferred. The wet coating thickness in the first step may be any thickness from about 4 to 10 microns, or even thicker (up to and including submersion) as long as the coating remains wet (contains sufficient water to behave as a liquid coating) for the period of time required for at least some nanoparticles to react with the glass substrate. It is not necessary that the coating liquid thickness is uniform at this step, so long as it is at least about 4 micron thick. Generally, very thin coatings are difficult to produce in field locations, and there is also the possibility that very thin wet coatings will evaporate before the nanoparticles can react with the glass substrate and a second step can be performed.

In some embodiments, application with a roller is preferred. Suitable rollers include 7.6 cm roller with 6.3 mm nap, Model Number 07981P, Shureline™ (supplied by Shureline, Hunterville N.C.), 22.9×7.8 cm diameter roller with 6.3 nap Number HD RC 100-9 130-273 (manufactured by Linzer Products Corporation and supplied by Home Depot, Atlanta Ga., Purdy White Dove Woven Dralon Fabric 9.5 mm nap roller (22.9 cm length, supplied by Purdy Corporation, Portland Oreg.), Wooster Pro Shed-Resistant 22.9 cm×9.5 mm Nap Roller (supplied by Wooster Brush Company, Wooster Ohio), FoamPRO 15 cm Fine Finisher, Super-Fine Foam roller (supplied by FoamPRO Manufacturing, Irvine Calif.) and the like. Almost any type of roller material is suitable, although it is preferable that the roller material should not be substantially damaged or degraded by the coating composition. As is well known in the art, rollers may be used with a roller handle or frame, which may be supplied as an integral part of the roller device or may be supplied separately, as, for example, 22.9 cm Heavy Duty Roller Frame SKU 418-312 (supplied by Home Depot, Atlanta Ga.).

The amount of time that is required for at least some nanoparticles to bond to the glass surface is a function of the nanoparticle size, the concentration of nanoparticles in the coating composition, the composition of the glass substrate, possible contaminants on the glass substrate, and pH. During this time, the coating must remain wet, and it will minimize labor costs for application if the time is shorter. Preferably, the time is less than 10 minutes, preferably less than 5 minutes, preferably less than 2 minutes, more preferably less than 1 minute. Preferably, it is not necessary to precisely control this time. In other words, in some embodiments, it is preferable that a range of times be used for a given coating composition. A minimum time may, however, be required, such as 30 seconds, preferably 20 seconds, more preferably 10 seconds.

Some embodiments include a second step wherein the thickness of the wet coating is reduced to between about 0.25 micron to 4 microns in thickness. In some embodiments, the wet coating thickness is reduced to between about 0.5 and about 3 microns in thickness.

Surprisingly, one method to reduce the wet coating thickness is to draw a flexible blade across the wet glass surface. In some embodiments, a hand-held flexible blade may be used. Flexible blades may be made of any rubbery material, such as natural rubber or polymers such as plasticized poly(vinylchloride), silicone polymers, polyurethanes, polyolefins, fluoropolymers, and the like. Flexible blades are often referred to as “squeegees.” The blade length may be of any practical dimension, such as between 7 and 70 cm. In some embodiments, the flexible blade is smaller than, larger than, or sized to match a particular glass substrate (e.g., designed so that it just fits inside the frame of a PV module). Various holders and handles may be combined with the blade. The blade may be positioned at any angle from about 5 to 90 degrees relative to the glass substrate, and may be drawn at various speeds from about 1 cm/sec to about 100 cm/sec. The blade tip may be of any geometry, including, for example, a symmetrical sharp edge, an assymetrical sharp edge, rounded, flat, or combinations thereof. The blade may be applied with various pressures combined with blade lengths in the range of about 1 to 60 gram/cm. The stiffness of the blade material, combined with the pressure applied and blade tip geometry, may determine the angle of the blade relative to the substrate, as well as the amount of blade that is in contact with the substrate. Preferably, it is not necessary to precisely control blade angle, speed, or pressure. In some embodiments, a hand-held blade may be used. Suitable commercially available flexible blades include, for example, Handy Trends Flexidry Model Number 01550 (silicone blade, length about 30.5 cm, Ningbo Haohan Cleaning Utinesils Co., Ltd, Cixi, Zhejiang, China), Sorbo black rubber blades of lengths 10 to 61 cm (Sorbo Products, Incorporated, Palm Desert Calif.) held in a Procurve™ handle (Mr. Longarm, Incorporated, Greenwood Md.) and the like. A wide variety of flexible blades are supplied by manufacturers such as Sorbo Products, Parish Maintenance Supply (Syracues N.Y.) and Ettore (Alameda Calif.). Blades may be supplied with handles or sold separately by these and other suppliers. Almost any type of flexible blade material is suitable, although it is preferable that the flexible blade material should not be substantially damaged or degraded by the coating composition.

In some embodiments, the wet coating thickness is reduced by applying a polymer film to the wet coated glass substrate. In some embodiments, the film is flexed and applied at an angle or rolled onto the wet coated glass substrate so that air bubbles are not entrapped. The film may adhere to the substrate due to the surface tension of the water in the coating composition (the total energy of the water in contact with glass and film is less than the energy of the water in contact with glass and air). Optionally, the film may be applied from a roll or be applied with the aid of a tool. Optionally, the film may be smoothed into place with the aid of a roller or flexible blade, and the optional roller or flexible blade may also help to squeeze out some coating composition or provide a more uniform thickness of coating composition. One advantage of using a film is that water cannot readily evaporate, so a longer amount of time can be used to allow the nanoparticles in the coating composition to react with the glass substrate. For example, a time of from 1 to 10 minutes, or even longer, may be used. However, depending on composition of the coating liquid, shorter times may also be used, including, for example, 20 second or less or 10 seconds or less.

The film is then removed from the substrate. Surprisingly, a uniform wet coating of coating composition having a thickness of 0.25 to 4 microns is left on the glass substrate. Any excess coating liquid can be removed with the film. Optionally, the film may be reused, which may be useful to help reduce waste. Suitable films may be made of almost any polymer and may be of almost any dimension, as long as they are sufficiently flexible that they will be able to contact the surface of the water in the liquid coating composition that is on the glass substrate. Thick, stiff films may not enable good contact with the water in the coating composition but instead will produce at least some areas where there is air between the film and the liquid coating composition that is on the glass substrate. Preferably, the film should be of a thickness from about 10 to 250 microns. The film may be transparent or non-transparent. Suitable polymers include polyolefins such as polyethylene and polypropylene, fluoropolymers, polyesters, polyacrylates, polystyrene, plasticized polyvinylchloride, and the like. It is preferable that the film material should not be substantially damaged or degraded by the coating composition.

Preferably, the wet coating thickness is in the range of 0.25 to 4 micrometers, more preferably 1 to 4 micrometers in the final step before evaporation of the water in the coating composition to form a durable coating. Evaporation may be accomplished by allowing the glass substrate to dry under ambient conditions, that is, to air dry. In some embodiments, substantially all of the water in the coating composition is evaporated, for example, at least 95% of the water is evaporated, preferably 98% of the water. Those skilled in the art will recognize that many materials, including glass and silica, may retain traces of water, particularly on their surfaces, depending on ambient conditions, unless they are subjected to combinations of high temperatures (such as over 100° C. or even over 200° C.) and very low pressure (such as 0.1 standard atmosphere or even 0.01 standard atmosphere). After evaporation, a durable coating is formed. A durable coating may be able to withstand cleaning, for example cleaning with the application of water, or to retain performance during a period of time outdoors where it may be subjected to rain or other conditions. The wet coating thickness is selected, in combination with the concentration of nanoparticles in the coating composition, to produce a dry coating (after evaporation) that has an average thickness of from about 0.5 to about 50 nm, more preferably about 2 to about 40 nm average thickness. Dry coating layer thicknesses higher than this range may have undesirable visual effects, and dry coating thickness that are lower than this range may have a reduced ability to prevent dust accumulation, reduced durability and/or reduced performance over a period of time outdoors.

When the coating composition contains nanopaticles of two or more sizes, with some nanoparticles whose diameter is less than 20 nm (e.g., “small” nanoparticles of diameter 4 nm) and some nanoparticles whose diameter is greater than 20 nm (e.g., “large” nanoparticles of diameter 42 nm), a dry coating may have an average thickness over an area of 2 micron by 2 micron, but over a smaller area (such as 40 nm×40 nm), there may be a large particle protruding from the coating for a thickness of 50 nm, and over another smaller area 40 nm×40 nm there may be only about 5 layers of small nanoparticles for a thickness of about 20 nm. Thus the surface of the dry coating may be rough on the scale of nanometers and such roughness may be detected by, for example, atomic force microscopy. It may also be possible to measure these various thicknesses by examining a cross-section of coating by, for example, scanning electron microscopy. As used herein, the term “average coating thickness” refers to the coating thickness over an area that is at least 20 times larger than the largest nanoparticle in the liquid coating composition, for example, for a liquid coating composition containing nanoparticles of diameters 4 nm and 42 nm, the average coating weight refers to the coating weight over an area of at least 0.84 micron×0.84 micron. In some embodiments, the dry coating is of a uniform thickness. In some embodiments, the average coating thickness over any (microscopic) area of 2 microns×2 microns is within 30% of the average coating thickness over a (macroscopic) area of 10 cm×10 cm.

Preferred embodiments have a dry, durable coating that have an average surface roughness of between about 3 nm and about 75 nm over a 5 microns by 5 microns area. In some embodiments, the durable coating has a surface roughness of between about 5 nm and about 40 nm over a 5 microns by 5 microns area.

In some embodiments, after coating the surface of the substrate, the resultant article is positioned outdoors and may be modestly heated due to ambient conditions surrounding the coated article or absorption of radiant energy with resultant heating. However, as a practical matter such events may not occur reliably, and the coating composition and method preferably produce a suitably durable coating without any subsequent requirements for heat or deliberate steps to heat it.

Objects and advantages of this disclosure are further illustrated by the following non-limiting examples, but the particular materials and amounts thereof recited in these examples, as well as other conditions and details, should not be construed to unduly limit this disclosure.

### EXAMPLES

### Materials

Nanoparticles

Spherical silica nanoparticle dispersions used are commercially available from the Nalco Company, an Ecolab Company, Naperville, Ill. under the trade designations: “NALCO 1115” (4 nm particles, supplied as about 16% by weight in water), NALCO 2326″ (5 nm particles, supplied as about 16% by weight in water), “NALCO DVSZN004” (42 nm particles, supplied as about 41% by weight in water), and “NALCO 2329” (75 nm particles, supplied as about 41% by weight in water).

Other Additives

Titanium oxide nanoparticles were supplied by Sigma-Aldrich (Sigma-Aldrich, St. Louis Mo.), Product Number 700347 (21 nm primary particle size, 150 nm particle size (DSL), 33-37% by weight in water). Nitric was 1.0 N nitric acid, supplied by VWR International, Catalog Number BDH 3209-1 (VWR International, West Chester Pa.).

Substrates

The glass used as a substrate for coating and for control experiments was Starphire™ low-iron glass, 3.2 mm thick, supplied by PPG Industries, Cheswick Pa. Starphire glass is produced as “float glass” by floating a molten ribbon of glass onto a pool of molten tin, and one side of the glass so produced has a higher content of tin than the other side. The side of the glass that had not been in contact with molten tin was used for the experiments unless otherwise indicated. In some cases, as indicated, the opposite side of the glass was covered with black backing (3M™ Scotchlite™ Removable Reflective Graphic Film with Comply™ Adhesive 680-CR65Black, supplied by 3M Company, St Paul Minn.), applied evenly with a roller. The black backing enabled reproducible gloss measurements on the glass side of the sample (opposite the backing).

The mirrors used as substrates for coating and for control experiments were Guardian standard mirror, 0.32 mm thick (Guardian Industries, Auburn Hills Mich.) or Binswanger Scargard™, 3.2 mm thick (Binswanger Glass, Memphis Term.), as indicated.

Unless otherwise indicated, substrates were cleaned by gently scrubbing with a solution of Liquinox detergent (Alconox, Inc. White Plains N.Y.) and a paper towel, followed by thorough rinsing with either running tap water or running deionized water, followed by a final rinse with deionized water, then air-drying, prior to use.

Test Methods:

Atomic Force Microscopy (AFM)

AFM analyses were performed using a Dimension™ 3100 Atomic Force Microscope (supplied by Veeco Metrology Group. Tucson Ariz.) in tapping mode. The probes were 1 ohm silicon probes (OTESPA) with spring constants between 20 and 80 Newton/meter and resonance frequency approximately 310 kHz. Imaging parameters were about 68 to 780% of the set point, and the driving amplitude was about 40 to 60 mV. Gains were 04 to 0.6 for integral gain and 0.5 to 0.7 for proportional gain. Scan rate was about 1 Hz for 5 micron×5 micron area, with 512×512 data points collected. Data processing for topography used 1^{st} order XY plane fitting and zero order flattening and data processing for phase used zero order flattening.

Field Effect Scanning Electron Microscopy (SEM)

Imaging was performed with a Hitachi S-4700 Field Emission Scanning Electron Microscope (supplied by Hitachi High Technologies America, Inc., Schaumburg Ill.). Sample preparation was as follows: For surfaces, the middle of each sample was examined to examine approximately the same area as AFM analysis. For cross-sections, the samples were marked around the edge with ink to denote the side of interest and the original edge. Cross-sections of the samples were created by hitting the sample with a ball-peen hammer. The smaller pieces were attached to SEM stubs for cross-section viewing of a fresh fractured edge. For both surface and cross-sections, a thin layer of AuPd was deposited to make the samples conductive.

Imaging conditions were 3.0 kiloelectron volts with a 6 mm working distance from the gun to the samples, with Ultra High Resolution-Analytical setting, image capture in 16 seconds, and tilt angle of 0 degrees. Magnifications of less than 1000 to as high as 50,000 were used to examine surfaces, and magnification of as high as 100,000 was used to examine cross-sections.

Gloss

Gloss measurements were performed with a BYK micro-Tri-Gloss Meter, Cat. No. AG-4448 (BYK-Gardner USA, Columbia Md.) which measures gloss at angles of 20, 60 and 85 degrees. Unless otherwise noted, 3 measurements were made at each angle on each sample, and the average of the 3 measurements is reported.

For outdoor performance testing initial gloss measurements were taken at 3 angles for 5 duplicate pieces of glass at 3 measurement angles (average of all measurements is reported in Table 4) Samples were then affixed with double-sided foam-core tape to an aluminum mounting, and mounted at a 45 degree angle on outdoor tests sites in Cottage Grove Minn. and Phoenix Ariz. After a period of time, gloss measurements were again taken (3 locations on 5 duplicates), to measure the amount of soil that had accumulated on the samples. The MN samples were placed outdoors on Mar. 28, 2012 and measured on Jun. 16, 2012. The AZ samples were placed outdoors on Apr. 14, 2012 and measured on May 16, 2012. For ease of comparison, the percentage loss of gloss over this period of time is calculated as Gloss Loss, %=100×(initial gloss−exposed gloss)/(initial gloss). A larger number for Gloss Loss, % means that more soil has accumulated.

Specular Reflectance

Specular reflectance measurements were performed with a Devices and Services Company Specular Reflectometer Model 15 R (Devices and Services Company, Dallas Tex.), at an acceptance angle of 15 milliradians. The number reported is the percentage of light captured over this acceptance angle. Unless otherwise noted, 3 measurements were made on each sample, and the average of the 3 measurements is reported.

Dry Dust Test

Pieces of substrate to be tested were cut to a size of about 10×15 cm. Samples (uncoated, partially coated or fully coated substrates, as indicated) were placed in racks that allowed good air circulation around the entire sample, and then placed in a controlled a humidity room at 10% relative humidity at about 20° C. The samples were allowed to equilibrate with the surroundings for at least 6 hr. Arizona Test Dust Fraction, 0—Specified Grade, Nominal 0-70 micron (Powder Technology, Inc., Burnsville, Minnesota) was placed in shallow pans in the controlled humidity room and allowed to equilibrate with the surroundings for at least 6 hr.

The sample was placed in a horizontal position in a polypropylene snap-top container (Sterilite Ultra-Seal™, length 23.2 cm, width 16.8 cm, height 6.4 cm, 1.4 L capacity, Sterilite Corporation, Townsend Mass.) with the side to be tested facing up. About 10 g of fresh (previously unused) Arizona Test Dust was dropped onto the sample with a metal spatula, then the container lid was snapped shut and the container was tipped gently back and forth so that the dust moved across the surface of the sample, 1 tip per second, for a total of 1 minute of movement. The lid was then removed, the sample was lifted to a vertical position, tapped once gently, and then the soil remaining on the surface was measured by using either gloss or specular reflectance, as indicated in the Tables below. As the amount of dust on a sample increases, the gloss and specular reflectance measurement decreases. The dust was discarded after use with one sample, and fresh dust was used for the each sample tested.

### Comparative Example 1

The amount of dust accumulated by uncoated glass as measured by specular reflectance measurements on pieces of Guardian standard mirror glass is shown in Table 1. These data are the results of 3 measurements per piece of glass, according to the “Dry Dust Test” method but setting the test chamber to different relative humidities and allowing a fresh sample of glass and dust to equilibrate for at least 6 hr at the indicated relative humidity. Visually, the samples appeared to be substantially covered with dust after exposure to the dust at the lowest relative humidities, and to have a finer thin layer of dust at higher relative humidities. The specular reflectance of the mirror before exposure to dust was 88.

Additional experimentation showed that longer equilibration times did not affect the test results, but shorter equilibration times did not provide reproducible results. Additional experimentation showed that different results were obtained using Arizona Test Dust Fractions of different sizes and size distributions. Additional experimentation determined that the best way to measure performance for coated samples was to coat half of a piece of glass and compare the measurements for the coated and uncoated halves of the piece; this helped to reduce variability that may be due to day-to-day, lot-to-lot, operator-to-operator or other sources of variability.

TABLE 1
Specular reflectance of uncoated glass mirror after Arizona Test Dust
exposure as a function of relative humidity (Comparative Example 1)

| Relative Humidity | Specular reflectance after dust exposure |
|---|---|
| 5% | 0.9 |
| 15% | 40.4 |
| 25% | 52.2 |
| 35% | 74.4 |
| 45% | 73.9 |
| 55% | 76.5 |
| 65% | 77.6 |
| 75% | 81.6 |

### Comparative Examples 2-17 and Examples 1-7

### Preparation of Coating Liquids and Coated Glass Substrates

Coating liquids were prepared by placing deionized water into a container in the quantities listed in Table 2 and adding nanoparticles in the amounts show (the amount shown is the weight of the nanoparticle solution as supplied). The liquids were then stirred during the addition of acid until the indicated pH was reached; the amount of acid required to achieve this pH was recorded. The pH of the solution was measured with pH strips (ColorpHast™ pH Test Strips, supplied by EMD-Millipore, EMD Chemicals, Inc., Gibbstown N.J.).

Substrates were pieces of Starphire™ glass, about 10×15 cm. The side of the glass that had not been in contact with molten tin was used for the experiments in Tables 3, and the opposite side of the glass (the side that had been in contact with the tin) was covered with black tape. Samples were coated by submerging the lower half of the piece of glass into a polyethylene beaker containing the coating liquid, waiting for the time indicated in the table in seconds (“Soak 60” means the sample was submerged for 60 seconds). In the second step for some samples a Comparative method was used, and the sample was withdrawn from the coating liquid over a period of 1-3 seconds and immediately (within 1-2 seconds) rinsed (“Rinse” in Table 2) thoroughly with running tap water followed by rinsing with deionized water. The samples were then allowed to air dry under ambient conditions. In the second step for some samples an Example of one of the methods of this application was used, and the sample was withdrawn from the coating liquid over a period of 1-3 seconds and then a squeegee (“SQG” in Table 2) was immediately (within 2-4 seconds) used to remove all but a very thin amount of coating liquid. The samples were then allowed to air dry under ambient conditions.

For Comparative Example 3 (CE3), the sample was allowed to soak for 60 sec, then withdrawn from the coating liquid and allowed to air dry without any other steps. The resulting coated substrate was unacceptably hazy by visual inspection, and was not tested further. Comparative Example 12 (CE12) was also unacceptable as it affected initial optical performance, as measured by gloss measurements before exposure to dust: the uncoated glass half showed a gloss of 94 when measured at 60 degrees, while the coated half of Comparative Example 12 showed a gloss of 68 when measured at 60 degrees.

TABLE 2
Coating Liquids and Coating Methods

| | Coating Composition (grams) | | | | | | | | |
|---|---|---|---|---|---|---|---|---|---|
| | | Nalco | Nalco | Nalco | Nalco | | Nitric | | Coating |
| EX# | Water | 1115 | 2326 | DVSZN | 2329 | TiO2 | acid | pH | Method |
| CE2 | 446.25 | 43.83 | 0 | 7.41 | 0 | 0 | 9.2 | 3.0 | Soak 60, Rinse |
| EX1 | 446.25 | 43.83 | 0 | 7.41 | 0 | 0 | 9.2 | 3.0 | Soak 60, SQG |
| CE3 | 446.05 | 43.89 | 0 | 7.41 | 0 | 0 | 9.2 | 3.0 | Soak 60, dry |
| CE4 | 468.10 | 31.25 | 0 | 0 | 0 | 0 | 3.0 | 3.0 | Soak 60, Rinse |
| EX2 | 468.10 | 31.25 | 0 | 0 | 0 | 0 | 3.0 | 3.0 | Soak 60, SQG |
| CE5 | 343.60 | 156.25 | 0 | 0 | 0 | 0 | 31.1 | 3.0 | Soak 60, Rinse |
| EX3 | 343.60 | 156.25 | 0 | 0 | 0 | 0 | 31.1 | 3.0 | Soak 60, SQG |
| CE6 | 343.60 | 156.25 | 0 | 0 | 0 | 0 | 31.1 | 3.0 | Soak 10, Rinse |
| CE7 | 345.80 | 156.81 | 0 | 0 | 0 | 0 | 0.0 | 11.0 | Soak 60, Rinse |
| CE8 | 345.80 | 156.81 | 0 | 0 | 0 | 0 | 0.0 | 11.0 | Soak 60, SQG |
| CE9 | 437.70 | | 0 | 61.61 | 0 | 0 | 9.1 | 2.0 | Soak 180, Rinse |
| CE10 | 437.70 | | 0 | 61.61 | 0 | 0 | 9.1 | 2.0 | Soak 60, SQG |
| EX4 | 448.80 | | 44.22 | 7.60 | 0 | 0 | 6.1 | 2.5 | Soak 60, SQG |
| CE11 | 445.42 | 46.89 | 0 | 0 | 7.52 | 0 | 10.3 | 3.0 | Soak 60, Rinse |
| EX5 | 445.42 | 46.89 | 0 | 0 | 7.52 | 0 | 10.3 | 3.0 | Soak 60, SQG |
| CE12 | 442.89 | 32.03 | 0 | 12.46 | 0 | 14.42 | 7.1 | 3.0 | Soak 60, SQG |
| CE13 | 459.10 | 0 | 0 | 0 | 0 | 42.93 | 0.0 | 3.0 | Soak 60, Rinse |
| CE14 | 459.10 | 0 | 0 | 0 | 0 | 42.93 | 0.0 | 3.0 | Soak 60, SQG |
| CE15 | 459.10 | 31.50 | 0 | 0 | 0 | 42.93 | 5.9 | 3.0 | Soak 60, SQG |
| CE16 | 446.05 | 0 | 44.17 | 0 | 7.52 | 0 | 5.0 | 3.0 | Soak 60, Rinse |
| EX6 | 446.05 | 0 | 44.17 | 0 | 7.52 | 0 | 5.0 | 3.0 | Soak 60, SQG |
| CE17 | 465.59 | 15.60 | 0 | 18.61 | 0 | 0 | 6.3 | 2.0 | Soak 60, Rinse |
| EX7 | 465.59 | 15.60 | 0 | 18.61 | 0 | 0 | 6.3 | 2.0 | Soak 60, SQG |

Dust Test Performance

The Examples and Comparatives shown in Table 2 were exposed to Arizona Test Dust at 10% relative humidity as described in “Dry Dust Test”. The gloss was measured after dust exposure for the uncoated (Comparative, and used as a Control measurement for uncoated performance) and coated half of each piece of glass. The difference between the coated and uncoated represents the performance of the coating, with larger differences indicating better performance, that is, less dust accumulated by the coated half as compared to the uncoated half. Where the difference is a negative number, it means that there was more dust on the coated half than on the uncoated half.

Examination of the data in Table 3 shows that, while some Comparative samples help to prevent dust accumulation, the Examples of the present application provide improved performance. For example, compare Comparative CE2 and Example EX1, which were made with the same coating composition but applied using different methods. Similarly, compare Comparative CE4 with Example EX2, or Comparative CE5 with Example EX3, Comparative CE11 with Example EX5 and Comparative CE17 with Example EX7. Other comparative examples that may help to prevent dust accumulation in this laboratory test, may not provide sufficient outdoor performance or durability, or may not meet environmental, safety, appearance or other requirements.

TABLE 3
Gloss of Coated Glass, before and after Arizona Test Dust Exposure

| | Gloss Measurement | | | | | | Difference, Coated − | | |
|---|---|---|---|---|---|---|---|---|---|
| | 20 | | 60 | | 85 | | Uncoated | | |
| # | Coated | Uncoated | Coated | Uncoated | Coated | Uncoated | 20 | 60 | 85 |
| CE2 | 77.9 | 75.7 | 70.8 | 65.8 | 29.1 | 20.0 | 1.9 | 5.5 | 9.1 |
| EX1 | 82.9 | 68.2 | 82.3 | 54.2 | 57.0 | 10.3 | 13.5 | 26.3 | 46.7 |
| CE4 | 76.9 | 68.7 | 69.5 | 54.8 | 25.3 | 5.4 | 13.9 | 21.2 | 20.0 |
| EX2 | 83.5 | 69.0 | 82.5 | 56.4 | 53.2 | 8.6 | 16.1 | 28.3 | 44.6 |
| CE5 | 82.1 | 80.6 | 79.5 | 74.8 | 50.3 | 35.3 | 1.8 | 5.3 | 15.0 |
| EX3 | 83.3 | 76.2 | 86.8 | 67.9 | 81.8 | 19.3 | 9.0 | 22.4 | 62.6 |
| CE6 | 77.6 | 77.3 | 72.3 | 71.0 | 42.1 | 29.7 | −0.9 | 0.4 | 12.3 |
| CE7 | 79.5 | 79.6 | 74.0 | 74.2 | 39.2 | 37.6 | 0.5 | 0.8 | 1.6 |
| CE8 | 84.3 | 70.6 | 86.6 | 58.7 | 69.9 | 12.9 | 13.3 | 27.2 | 57.0 |
| CE9 | 62.2 | 76.8 | 47.5 | 67.7 | 7.8 | 19.6 | −13.5 | −19.0 | −11.8 |
| CE10 | 77.5 | 65.0 | 76.5 | 51.8 | 49.4 | 6.1 | 14.6 | 27.8 | 43.4 |
| EX4 | 84.2 | 67.7 | 85.7 | 53.8 | 70.7 | 9.4 | 15.9 | 31.0 | 61.3 |
| CE10 | 63.7 | 73.2 | 59.1 | 63.3 | 26.5 | 13.5 | −8.3 | −1.9 | 12.9 |
| EX5 | 84.8 | 76.4 | 86.3 | 66.6 | 76.3 | 23.7 | 8.6 | 19.4 | 52.7 |
| CE12 | 79.0 | 71.4 | 73.5 | 59.9 | 36.3 | 11.9 | 8.4 | 14.6 | 24.4 |
| CE13 | 35.4 | 71.8 | 54.9 | 62.3 | 35.0 | 20.2 | −38.4 | −9.1 | 14.7 |
| CE14 | 57.7 | 67.1 | 49.1 | 53.8 | 8.2 | 9.0 | −9.9 | −5.7 | −0.9 |
| CE15 | 55.5 | 72.6 | 38.8 | 61.5 | 6.5 | 14.7 | −17.9 | −23.5 | −8.3 |
| CE16 | 81.3 | 76.1 | 77.1 | 66.4 | 39.5 | 21.5 | 5.0 | 9.9 | 18.0 |
| EX6 | 79.2 | 63.0 | 78.5 | 48.9 | 51.0 | 9.2 | 14.4 | 27.4 | 41.7 |
| CE17 | 72.3 | 76.1 | 59.5 | 66.6 | 12.5 | 15.0 | −2.3 | −4.3 | −2.5 |
| EX7 | 82.9 | 74.6 | 82.8 | 63.8 | 59.8 | 14.3 | 11.0 | 22.4 | 45.5 |

### Comparatives Examples 18-19 and Examples 8-9

### Durability

A coating composition “CC1” was prepared using the mixing sequence described above for coating liquids in Table 2, using 1103 g deionized water, 320 g “NALCO 1115” and 55.6 g “NALCO DVSZN004”, adjusted to pH 3.0 with 77.3 g 1 N nitric acid. The silica concentration was about 5% solids by weight. A second coating composition “CC2” prepared by mixing 100 g of “CC1” with 100 g deionized water, to give a solution of about 2.5% solids by weight and pH about 3.3. These coatings were applied to pieces of Starphire™ glass, about 15×15 cm size, as described below. After the coatings had dried, the samples were analyzed by Scanning Electron Microscopy (SEM) and Atomic Force Microscopy (AFM) as described under test methods.

### Comparative Example 18

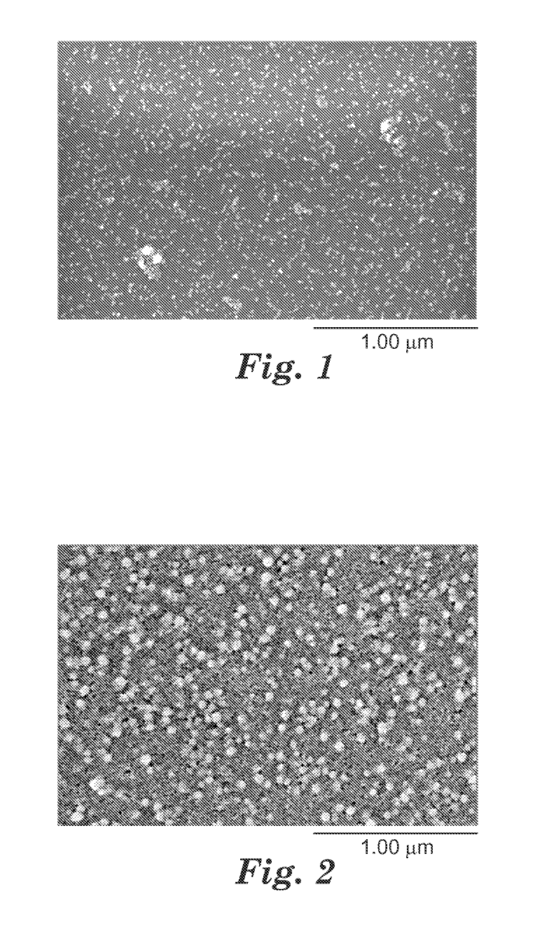

Using coating composition “CC1”, a piece of glass was submerged in the coating composition for 300 seconds, then removed, rinsed thoroughly with deionized water, and air-dried. SEM at 15,000 and 50,000 magnification showed the presence of 4 nm silica nanoparticles on the surface, at a very low rate of coverage, much less than of a monolayer of particles, such that bare substrate glass was exposed over most of the surface. Over a sample area of about 2×3 micron, SEM showed about four 42 nm nanoparticles. AFM particle analysis showed that there were 256 particles of size 4.1 nm (number average height) over an area of 1×1 micron, which means that the nanoparticles covered about 0.3% of the glass surface. The SEM image at 50,000 magnification is shown in FIG. 1. This image is taken of the surface of the sample, that is, the image was taken perpendicular to the surface. The bare glass appears dark, and the small lighter dots are 4 nm particles. The larger, brighter dots are 42 nm particles (about four individual particles are seen in this image). Over the raster scan line in the AFM measurement, no 42 nm particles were detected; a few large particles were observed over a 2×2 micron area but statistically the chances of detecting these with a single random raster scan line are small. Rq (Root-Mean-Square) roughness for 5×5 micron image was 3.2 nm, average roughness over the same area was 2.0 nm.

The coated sample was submitted to sonication for 5 minute (Aquasonic Model 250T, supplied by VWR International, Radnor Pa.). Cleaning by sonication is very effective for removing small particles from a surface After sonication, SEM analysis showed that many of the 4 nm nanoparticles were removed; the number of 42 nm particles remaining was similar, although both before and after sonication the coverage was very low, less than 10 of the 42 nm particles per 2×3 micron area.

### Comparative Example 19

Using a foam roller (“FoamPRO 15 cm Fine Finisher, Super-Fine Foam”, available from FoamPRO Manufacturing, Irvine Calif.) coating composition “CC2” was applied to a piece of glass and allowed to remain there for 45 seconds. The glass was then thoroughly rinsed with deionized water, and air-dried. SEM at 15,000 magnification showed the presence of 4 nm silica nanoparticles on the surface, at a very low rate of coverage, much less than of a monolayer of particles and less than Comparative Example CE18, such that bare substrate glass was exposed over most of the surface. AFM particle analysis showed that there were 152 particles of size 4.7 nm (number average height) over an area of 1×1 micron. The raster scan line in the AFM measurement detected one 42 nm particle, as the randomly selected raster scan line happened to include one such particle. Rq (Root-Mean-Square) roughness for 5×5 micron image was 3.6 nm, average roughness was 2.4 nm over the same area.

### Example 8

Using a foam roller (“FoamPRO 15 cm Fine Finisher, Super-Fine Foam”, available from FoamPRO Manufacturing, Irvine Calif.) coating composition 3002 was applied to a piece of glass and allowed to remain there for 45 seconds. Most of the coating solution was then removed with a flexible blade, and the sample was air-dried. SEM at 15,000 and 50,000 magnification showed the presence of 4 and 42 nm silica nanoparticles on the surface, at a rate of coverage such that the nanoparticles completely covered the glass substrate, that is, at least one monolayer. The SEM image at 50,000 magnification is shown in FIG. 2. The image is taken of the surface of the sample. The image shows that surface is almost or entirely covered with 4 nm particles and many 42 nm particles are also seen. The thickness of the coating cannot be determined from this image. Particle analysis was not possible by AFM because there was no bare glass baseline from which to measure. Rq (Root-Mean-Square) roughness for 5×5 micron image was 8.1 nm, average roughness was 6.5 nm over the same area.

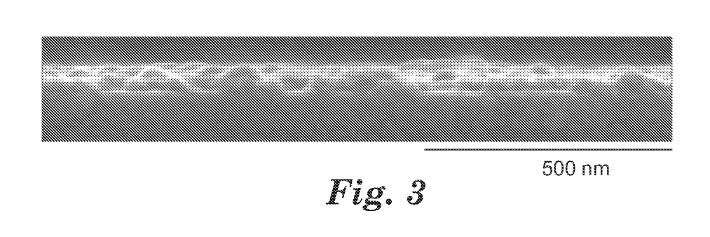

A cross-section of Example 8 was examined by SEM at 100,000 magnification. The coating appeared to be about 50-60 nm thick where there were large (42 nm) particles, and about 25 nm thick where the coating was comprised of several layers of small (4 nm) particles. The average thickness was less than 50 nm. The 42 nanometer particles protruded out of the thinner sections comprising 4 nm particles. The SEM image of this cross-section is shown in FIG. 3. In this image, the glass substrate is very dark and is shown below the coating. From this cross-section, we estimated the average thickness of the dry coating to be about 40 nm (averaged over the thicknesses of 50-60 nm where there are large nanoparticles and 25 nm where there are several layers of small nanoparticles) and from that we calculated the approximate wet coating after the second step (flexible blade) as follows: Assuming the density of silica nanoparticles to be 2.65 g/cm³ (the density of silica) and the dry coating to consist of randomly close-packed spheres occupying about 64% of the volume, the density of the dry coating is about 1.7 gm/cm³. For an average thickness 40 nm, the volume of over an area 1 cm×1 cm is 4×10⁻⁶ cm³ and the weight over this area is 6.8×10⁻⁶ g. Since the coating composition was 2.5% silica (weight % solids), the wet coating over an area of 1 cm×1 cm must have been 2.72×10⁴ gram. The density of the coating composition is 1.0 gm/cm³, so the wet coating thickness over an area of 1 cm×1 cm was 2.72×10⁴ cm=2.72 micron.

### Example 9

Using a foam roller (“FoamPRO 15 cm Fine Finisher, Super-Fine Foam”, available from FoamPRO Manufacturing, Irvine Calif.) coating composition “CC2” was applied to a piece of glass and then covered with a film of ETFE (ethylene-tetrafluororethylene copolymer). The film was smoothed down with a flexible blade. After 45 seconds, the film was peeled off and the sample was air-dried. SEM at 15,000 and 50,000 magnification showed the presence of 4 and 42 nm silica nanoparticles on the surface, at a rate of coverage such that the nanoparticles completely covered the glass substrate, that is, at least one monolayer. Particle analysis was not possible by AFM because there was no bare glass baseline from which to measure. Rq (Root-Mean-Square) roughness for 5×5 micron image was 10.3 nm, average roughness was 8.6 nm over the same area.

A cross-section of Example 9 was examined by SEM at 100,000 magnification. The coating appeared to be about 50 nm thick were there were large (42 nm) particles, and about 25 nm thick where the coating was comprised of several layers of 4 nm particles. The average thickness was less than 50 nm. The 42 nanometer particles protruded out of the thinner sections comprising 4 nm particles.

The coated sample was submitted to sonication for 5 minutes, as described above for Comparative CE18. Cleaning by sonication is very effective for removing small particles from a surface. This sonication method/SEM analysis is used as a means to show bonding of nanoparticles to the glass substrate. After sonication, SEM analysis showed no significant change; that is, all of the particles appear to be durably attached to the glass substrate.

### Comparatives 20-21 and Examples 10-11

### Outdoor Performance

A coating composition was prepared as in Example EX1, with pH of 3.0 (+/−0.5) pH units. This coating was applied to pieces of Scargard™ mirror about 10×15 cm size for the following comparatives and examples. Outdoor performance testing was then done as described under “Gloss” in the test methods.

### Comparative Example 20

No coating was applied.

### Comparative Example 21

The piece of glass was placed horizontally so that it was submerged in the coating composition in a shallow tray, and submerged for 30 sec. Then it was removed and rinsed with a stream of deionized water. The sample was allowed to air-dry (“30 sec Soak, Rinse” in Table 4).

### Example 10

The coating composition was applied to the glass using two passes of a foam roller (“FoamPRO 15 cm Fine Finisher, Super-Fine Foam”, available from FoamPRO Manufacturing, Irvine Calif.) that had been rolled in a tray of coating liquid to saturate the foam with the liquid. The liquid was in contact with the glass for 30 sec before a substantial portion of the liquid was removed with a black rubber blade at about 110 gram pressure over the 10 cm contact line (about 11 g/cm). The sample was allowed to air dry (“Roll, 30 sec, Blade” in Table 4).

### Example 11

The coating composition was applied to the glass as for Example EX12, then a piece of ETFE film (thickness 102 micron, about 15×19 cm) was placed on top of the coating liquid and smoothed in place with a black rubber blade at about 300 g pressure over the 10 cm contact line. After the film was in place for 30 sec, it was peeled back at about a 90-degree peel angle. The coated glass was allowed to air-dry (“Roll, Film 30 sec, Peel” in Table 4).

TABLE 4
Gloss before and after outdoor exposure

| | | | | | Gloss after | | | Gloss Loss after | | |
|---|---|---|---|---|---|---|---|---|---|---|
| | | Initial Gloss | | | Exposure Outdoors | | | outdoor Exposure, % | | |
| # | Coating Method | 20 | 60 | 85 | 20 | 60 | 85 | 20 | 60 | 85 |

Arizona

| | | | | | | | | | | |
|---|---|---|---|---|---|---|---|---|---|---|
| CE20 | No Coating | 1812 | 839 | 136 | 1625 | 726 | 80 | 10.3 | 13.5 | 41.6 |
| CE21 | 30 sec Soak, Rinse | 1809 | 836 | 136 | 1648 | 728 | 88 | 8.9 | 12.9 | 35.0 |
| EX10 | Roll, 30 sec, Blade | 1805 | 834 | 136 | 1682 | 753 | 98 | 6.8 | 9.8 | 27.8 |
| EX11 | Roll, Film 30 sec, Peel | 1795 | 830 | 135 | 1660 | 742 | 93 | 7.5 | 10.6 | 30.7 |

Minnesota

| | | | | | | | | | | |
|---|---|---|---|---|---|---|---|---|---|---|
| CE20 | No Coating | 1809 | 831 | 131 | 1719 | 770 | 119 | 5.0 | 7.3 | 8.8 |
| CE21 | 30 sec Soak, Rinse | 1811 | 833 | 131 | 1740 | 784 | 121 | 3.9 | 5.8 | 7.9 |
| EX10 | Roll, 30 sec, Blade | 1806 | 829 | 130 | 1741 | 786 | 120 | 3.6 | 5.2 | 7.8 |
| EX11 | Roll, Film 30 sec, Peel | 1806 | 830 | 131 | 1743 | 790 | 121 | 3.5 | 4.8 | 7.2 |

### Examples 12 to 19

Multiple coating liquid samples (EX 12 to EX 19) were prepared by charging a container with the target amounts of 200.00 g purified water (purified either by distillation, deionization or reverse osmosis), 21.00 g Nalco 1115, 3.33 g Nalco DVSZN004 and about 3.38 g 10% nitric acid solution (10% by weight nitric acid in water). Over multiple samples, the actual amount charged varied by up to 0.05 g and in some cases larger batches were prepared maintaining the same proportions. About 3 g of the nitric acid was added in each preparation and then the remainder was added in small portions until a pH of 2.75, as measured with a pH meter, was reached. These liquids contain 1.4% by weight of 4 nanometer particles and 0.6% by weight of 42 nanometer particles. The liquid samples were prepared and stored at ambient temperature for various lengths of time from one day to about 4 months, before coating samples of glass. In EX 20, the proportions were water 1102.7 g, Nalco 1115 320.0 g, Nalco DVSZN 004 55.6 g and 1 N nitric acid 77.3 g, to which additional water 1556 g was added, resulting In a liquid that contained 1.5% by weight 4 nanometer particles and 0.7% by weight 42 nanometer particles, with a pH of about 3.3.

Multiple samples of coated glass were prepared by the method of applying a thick layer of the coating liquid to the glass surface, using a paint roller, a pipette, immersion or similar methods, allowing the liquid to dwell for a length of time indicated in Table 5 on the glass, and then removing a portion of the liquid from the glass surface using a flexible blade (squeegee). The amount of liquid left after the squeegee step is called the “wet thickness” in Table 5. No attempt was made to measure or control the blade angle, speed, or pressure; this was simply application “by hand” by two different operators (“K” and “D”). The remaining “wet thickness” liquid was allowed to dry on the glass, and the coating was subsequently analyzed by scanning electron microscopy (SEM). From the SEM images and the composition of the liquid, we calculated what the wet thickness had been. The calculation was done by counting the number of 42 nm particles in an area 1 micron×1 micron in 2 to 4 separate SEM images of different portions of the coated samples. We knew the number of 42 nm particles in the original coating liquid (58 particles in a volume of 1×1×1 micron for a composition containing 0.6% by weight 42 nm silica particles), and we assumed that all the particles present in the wet thickness liquid were deposited on the glass as the water evaporated from the wet layer; thus, a wet thickness of 1 micron would have deposited 58 particles of size 42 nm in a 1×1 micron area. Proportionately thinner wet coatings would result in proportionately fewer 42 nm particles. Results are shown in Table 5 with the average thickness for each sample (based on 2-4 measurements of particle count).

TABLE 5
Wet thickness

| | | | | | 42 nm particle | | | | | |
|---|---|---|---|---|---|---|---|---|---|---|
| | Coating Liquid Composition | | | dwell | counts in SEM | | | | | |
| | 4 nm | 42 nm NP | | time, | images, in 1 × 1 | | | | Wet | |
| | NP amt, | amount, | | sec | micron area | | | | Thickness | |
| # | wt % | wt % | pH | sec | # | # | # | # | micron | Operator |
| EX 12 | 1.4 | 0.6 | 2.75 | 30 | 27 | 16 | 31 | 31 | 0.45 | K |
| EX13 | 1.4 | 0.6 | 2.75 | 30 | 17 | 21 | 19 | 24 | 0.35 | K |
| EX14 | 1.4 | 0.6 | 2.75 | 30 | 22 | 20 | 19 | 30 | 0.39 | K |
| EX 15 | 1.4 | 0.6 | 2.75 | 30 | 19 | 28 | 12 | 14 | 0.31 | K |
| EX 16 | 1.4 | 0.6 | 2.75 | 30 | 31 | 28 | 31 | 22 | 0.48 | K |
| EX 17 | 1.4 | 0.6 | 2.75 | 30 | 29 | 26 | | 21 | 0.44 | K |
| EX 18 | 1.4 | 0.6 | 2.75 | 60 | 25 | 16 | 16 | | 0.33 | D |
| EX 19 | 1.4 | 0.6 | 2.75 | 60 | 28 | 25 | | | 0.46 | D |
| EX20 | 1.5 | 0.7 | 3.3 | 45 | 65 | 66 | | | 0.97 | K |

It was observed that the wet coating thickness was surprisingly consistent for EX 12 through Ex 19, with the same coating composition, the wet coating thickness was an average of 0.40 micron, with a standard deviation of only 0.065 micron. Without wishing to be bound by theory, we believe that the coating composition plays a significant role in controlling the wet coating thickness when excess liquid is removed using a hand-held device, based on the flow of the liquid near the glass surface, which in particular may be influenced by the bonding of nanoparticles to the glass surface during the dwell time, and/or the nanometer-scale fluid flow that results from the presence of nanoparticles in the coating liquid. Note in Table 5, EX 20 that a 17% higher particle concentration results in an almost 100% higher wet thickness, and this may be due in part to a change in nanometer-scale fluid flow resulting from the higher nanoparticle concentration.

All references mentioned herein are incorporated by reference.

As used herein, the words “on” and “adjacent” cover both a layer being directly on and indirectly on something, with other layers possibly being located therebetween.

As used herein, the terms “major surface” and “major surfaces” refer to the surface(s) with the largest surface area on a three-dimensional shape having three sets of opposing surfaces.

Unless otherwise indicated, all numbers expressing feature sizes, amounts, and physical properties used in the present disclosure and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a”, “an”, and “the” encompass embodiments having plural referents, unless the content clearly dictates otherwise. As used in this disclosure and the appended claims, the term “or” is generally employed in its sense including “and/or” unless the content clearly dictates otherwise.

Various embodiments and implementation of the present disclosure are disclosed. The disclosed embodiments are presented for purposes of illustration and not limitation. The implementations described above and other implementations are within the scope of the following claims. One skilled in the art will appreciate that the present disclosure can be practiced with embodiments and implementations other than those disclosed. Those having skill in the art will appreciate that many changes may be made to the details of the above-described embodiments and implementations without departing from the underlying principles thereof. It should be understood that this invention is not intended to be unduly limited by the illustrative embodiments and examples set forth herein and that such examples and embodiments are presented by way of example only with the scope of the invention intended to be limited only by the claims set forth herein as follows. Further, various modifications and alterations of the present invention will become apparent to those skilled in the art without departing from the spirit and scope of the present disclosure. The scope of the present application should, therefore, be determined only by the following claims.

1. A method of forming a durable coating on a glass substrate, comprising:
applying a coating composition to a glass substrate, the applied coating composition having a thickness of greater than 4 microns; the coating composition consisting essentially of about 0.25% to about 10% by weight of non-oxidizing nanoparticles, an acid, and water;
allowing the coating composition to remain on the surface of the glass substrate for at least an amount of time sufficient for at least some of the nanoparticles to bond to the glass substrate;
using a tool to reduce the thickness of the coating composition to about 0.25 to 4 microns, and
evaporating at least some of the water to form the durable coating.

2. (canceled)

3. (canceled)

4. (canceled)

5. The method according to claim 1, wherein some of the non-oxidizing nanoparticles have a diameter of between about 2 nm and about 20 nm and some of the non-oxidizing nanoparticles have a diameter of between about 20 nm and about 75 nm.

6. The method according to claim 1, wherein the coating composition contains essentially no oxidizing materials or organic materials.

7. (canceled)

8. (canceled)

9. The method according to claim 1, wherein the amount of time sufficient to bond at least some of the nanoparticles is between about 5 seconds and about 60 seconds.

10. (canceled)

11. The method according to claim 1, wherein the coating composition is applied by at least one of flooding, rolling, wiping, and submerging.

12. The method of any of the preceding claimsaccording to claim 1, further comprising:
applying a pressure of between about 1 gram/cm and about 60 gram/cm while reducing the thickness of the coating composition.

13. The method according to claim 1, wherein the durable coating has an average thickness of between about 0.5 nanometers and about 50 nanometers.

14. (canceled)

15. (canceled)

16. (canceled)

17. The method according to claim 1, wherein the durable coating is substantially continuous.

18. (canceled)

19. (canceled)

20. The method according to claim 1, wherein the durable coating has an average surface roughness over a 5 micron by 5 micron area of between about 3 nm and about 75 nm.

21. (canceled)

22. (canceled)

23. (canceled)

24. (canceled)

25. The method according to claim 1, wherein the glass substrate is part of a photovoltaic module, window, or solar mirror.

26. (canceled)

27. A method of forming a durable coating on a glass substrate, comprising:
applying a coating composition to a glass substrate, wherein the coating composition consists essentially of about 0.25% to about 10% by weight of non-oxidizing nanoparticles, an acid, and water;
placing a polymer film adjacent to the coating composition;
removing the polymer film; and
evaporating substantially all of the water in the coating composition and thereby form the durable coating.

28. (canceled)

29. (canceled)

30. (canceled)

31. The method according to claim 27, wherein some of the non-oxidizing nanoparticles have a diameter of between about 2 nm and about 20 nm and some of the non-oxidizing nanoparticles have a diameter of between about 20 nm and about 75 nm.

32. The method according to claim 27, wherein the coating composition contains essentially no oxidizing materials or organic materials.

33. (canceled)

34. (canceled)

35. The method according to claim 27, wherein the amount of time sufficient to bond at least some of the nanoparticles between about 5 seconds and about 60 seconds.

36. (canceled)

37. The method according to claim 27, wherein the coating composition is applied by at least one of flooding, rolling, and submerging.

38. The method according to claim 27, further comprising:
applying a pressure of between about 1 gram/cm and about 60 gram/cm to the polymer film while it is positioned on the glass substrate and coating composition.

39. The method according to claim 27, wherein the durable coating has a thickness of between about 0.5 nanometers and about 50 nanometers.

40. (canceled)

41. (canceled)

42. The method according to claim 27, wherein the durable coating is substantially continuous.

43. (canceled)

44. (canceled)

45. (canceled)

46. The method according to claim 27, wherein the durable coating has a surface roughness of between about 5 nm and about 40 nm.

47. (canceled)

48. (canceled)

49. (canceled)

50. The method according to claim 27, wherein the glass substrate is part of a photovoltaic module, window, or solar mirror.

51. (canceled)

52. (canceled)

53. (canceled)
